(19) United States
(12) Patent Application Publication
(10) Pub. No.: US 2026/0346828 A1
(43) Pub. Date: Nov. 5, 2026

(54) ELECTRONIC BRAKE SYSTEM AND CONTROL METHOD THEREOF

(71) Applicant: HL MANDO CORPORATION, Pyeongtaek-si (KR)

(72) Inventor: Heechul JUNG, Pyeongtaek-si (KR)

(73) Assignee: HL MANDO CORPORATION, Pyeongtaek-si (KR)

(21) Appl. No.: 19/365,524

(22) Filed: Oct. 22, 2025

(30) Foreign Application Priority Data
Apr. 30, 2025 (KR) 10-2025-0057658

(51) Int. Cl. B60T 17/22; B60T 13/74

(52) U.S. Cl. CPC B60T 17/221; B60T 13/74; B60T 2240/00

(57) ABSTRACT

An electronic brake system is provided. The electronic brake system comprises: a motor that actuates or releases a parking brake; a first controller that controls the system and motor operation; and a second controller that identifies abnormal states of the first controller and controls motor operation accordingly. The second controller comprises a processor for identifying abnormal states and a switching module for controlling power supply to the motor under processor control.

### CROSS-REFERENCE TO RELATED APPLICATIONS

Pursuant to 35 U.S.C. § 119(a), this application claims the benefit of earlier filing date and right of priority to Korean Patent Application No. 10-2025-0057658, filed on Apr. 30, 2025, the contents of which are all hereby incorporated by reference herein in their entireties.

### BACKGROUND

Various embodiments of the present disclosure relate to an electric brake system and a method for controlling the same.

A brake system of a vehicle is one of the important elements directly related to vehicle safety. Traditional brake systems mainly operate using hydraulic or mechanical methods, but recently electronic brake systems are being applied more widely. In particular, the Motor on Caliper (MoC) method, which directly mounts a motor to the vehicle's brake caliper to control the brake, enables faster and more precise brake control.

Since the motor on caliper method is electronically controlled, a motor driver and corresponding electronic circuits are required to drive the motor. Generally, an electric motor is used, which is controlled by the motor driver.

In autonomous vehicles or high-performance vehicles, higher levels of brake control and reliability are required. In such vehicles, brake redundancy is very important, but conventional motor on caliper methods have insufficient redundancy, limiting the reliability of the brake system. In particular, when an abnormality occurs in the power supply, normal operation of the parking brake cannot be expected, resulting in degraded reliability of the brake system.

### SUMMARY

The features and advantages of the present disclosure will be more readily understood and apparent from the following detailed description, which should be read in conjunction with the accompanying drawings, and from the claims which are appended to the end of the detailed description.

An aspect of the disclosed invention is to provide an electronic brake system and control method thereof that can provide control redundancy to enable normal operation of a motor even when an abnormality occurs in a device controlling the motor's operation.

According to various embodiments of the present disclosure, an electronic brake system comprises: a motor configured to actuate or release a parking brake of the electronic brake system; a first controller configured to control operation of the motor in a normal state; and a second controller electrically connected between the first controller, a power supply unit of the vehicle, and the motor , the second controller configured to: identify an abnormal state of the first controller, and switch power supply paths for control operation of the motor based on the identification result, wherein the second controller comprises: a processor configured to identify the abnormal state of the first controller; and a switching module configured to switch power supply paths to the motor based on control by the processor, wherein the switching module is configured to: maintain the electrical connection between the first controller and the motor based on control by the processor when the first controller is in a normal state, and in response to identification of the abnormal state, disconnect the electrical connection between the first controller and the motor and form an electrical connection between the power supply unit and the motor so that the second controller controls the motor.

The switching module may be configure to maintain bypass connection between the first controller and the motor when the first controller is in a normal state.

The switching module may comprise at least one switching element configured to control connection between the first controller and the motor or between the power supply unit and the motor.

The switching module may comprise a first switching element and a second switching element connected in series between the first controller and the motor, wherein when the first controller is in a normal state, the first switching element and the second switching element connect the first controller and the motor based on control by the processor, and when the first controller is in an abnormal state, the first switching element operates to connect a power supply path from the power supply unit to the motor based on control by the processor, and the second switching element operates to connect a ground path of the motor based on control by the processor.

The switching module may comprise: a first switching element and a second switching element configured to control connection between the power supply unit and the motor when the first controller is in an abnormal state; and a third switching element and a fourth switching element connected in series between the first controller and the motor, wherein the first switching element is connected between the third switching element and the motor, and the second switching element is connected between the fourth switching element and the motor.

The processor may control the first switching element to connect the power supply unit and the motor for actuation of the parking brake based on first rotation of the motor, and may control the second switching element to connect the power supply unit and the motor for release of the parking brake based on second rotation of the motor.

The switching module may comprise: an H-bridge circuit including first, second, third, and fourth switching elements configured to control connection between the power supply unit and the motor based on control by the processor when the first controller is in an abnormal state; and a fifth switching element and a sixth switching element connected in series between the first controller and the motor.

The switching element may comprise any one of a mechanical relay, an electronic FET, and a BJT.

The second controller may further comprise a power storage module configured to store power supplied from the power supply unit.

The power storage module may comprise at least one capacitor and may supply power to the motor based on identification of an abnormal state of the power supply unit.

The processor may monitor a charging state of the power storage module and control it to maintain a preset voltage.

The second controller may control operation of the motor based on a wheel speed signal from a wheel speed sensor provided in the vehicle.

The processor may compare the wheel speed signal with a preset reference value and control operation of the motor based on the comparison result.

The second controller may receive status information of the first controller from the first controller, and the processor may identify the abnormal state of the first controller based on the status information.

According to some embodiments of the present disclosure, a control method for an electronic brake system comprises: monitoring, by a second controller of the electronic brake system, a state of a first controller; identifying, by the second controller, a normal state or abnormal state of the first controller based on the monitoring result; and switching power supply paths for operation of a motor that actuates or releases a parking brake of the electronic brake system based on the identification result.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows a diagram illustrating a configuration of an electronic brake system and a related vehicle according to one or more exemplary embodiments of the present disclosure.

FIG. 2 shows a diagram illustrating a circuit configuration of an electronic brake system according to one or more exemplary embodiments of the present disclosure.

FIG. 3 shows a diagram illustrating a configuration of a second controller of an electronic brake system according to one or more exemplary embodiments of the present disclosure.

FIG. 4 shows a diagram illustrating a configuration of a switching module of a second controller according to one or more exemplary embodiments of the present disclosure.

FIG. 5 and 6 show diagrams illustrating configurations of a switching module of a second controller according to other embodiment of the present disclosure.

FIG. 7 shows a diagram illustrating a configuration of a switching module of a second controller according to another embodiment of the present disclosure.

FIG. 8 shows a diagram illustrating a configuration of an H-bridge circuit shown in FIG. 7.

FIG. 9 shows a diagram illustrating a control method of an electronic brake system according to one or more exemplary embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

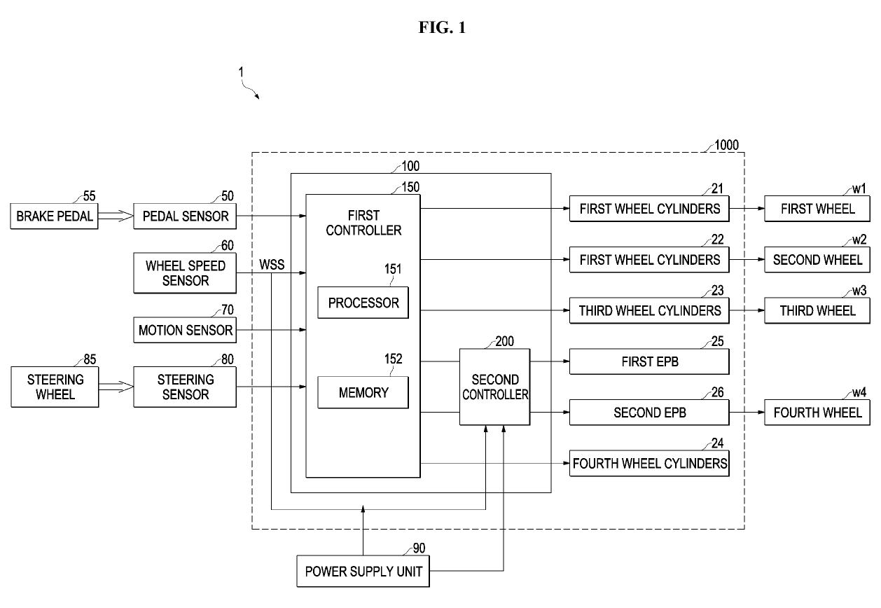

Referring to FIG. 1, a vehicle 1 may comprise a plurality of rotating wheels w1, w2, w3, w4.

The plurality of wheels w1, w2, w3, w4 may comprise, for example, a first wheel w1 provided at the front left (FL) of the vehicle 1, a second wheel w2 provided at the front right (FR) of the vehicle 1, a third wheel w3 provided at the rear left (RL) of the vehicle 1, and/or a fourth wheel w4 provided at the rear right (RR) of the vehicle 1. However, the number of wheels w1, w2, w3, w4 is not limited to four.

As shown in FIG. 1, the vehicle 1 comprises a brake pedal 55 that obtains braking input from a driver, a pedal sensor 50 that detects movement of the brake pedal 55, wheel speed sensors 60 that detect rotational speeds of the respective wheels w1, w2, w3, w4, a steering wheel 85 that obtains steering input from the driver, a motion sensor 70 that detects movement of the vehicle 1, a steering sensor 80 that detects rotation of the steering wheel 85, a power supply unit 90 that supplies power to the vehicle 1, and an electronic brake system 1000 that provides braking force to the plurality of wheels w1, w2, w3, w4 to stop the vehicle 1.

Here, the pedal sensor 50, wheel speed sensors 60, motion sensor 70, steering sensor 80, and power supply unit 90 are not essential components, and all or some of them may be omitted.

The electronic brake system 1000 comprises first and second wheel cylinders 21, 22 respectively provided on left and right wheels of a first axle of the vehicle 1, third and fourth wheel cylinders 23, 24 respectively provided on left and right wheels of a second axle of the vehicle 1, and a brake module 100 that sets target braking pressure based on output signals from the pedal sensor 50 and provides hydraulic pressure to the plurality of wheel cylinders 21, 22, 23, 24 based on the target braking pressure.

Here, the first axle of the vehicle 1 may be set as front wheels, and the second axle of the vehicle 1 may be set as rear wheels. However, this is not limiting, and depending on design, the first axle may be set as rear wheels and the second axle may be set as front wheels.

The plurality of wheel cylinders 21, 22, 23, 24 may respectively brake the wheels w1, w2, w3, w4 to brake the vehicle 1. For example, the first wheel cylinder 21 may brake the first wheel w1, the second wheel cylinder 22 may brake the second wheel w2, the third wheel cylinder 23 may brake the third wheel w3, and the fourth wheel cylinder 24 may brake the fourth wheel w4.

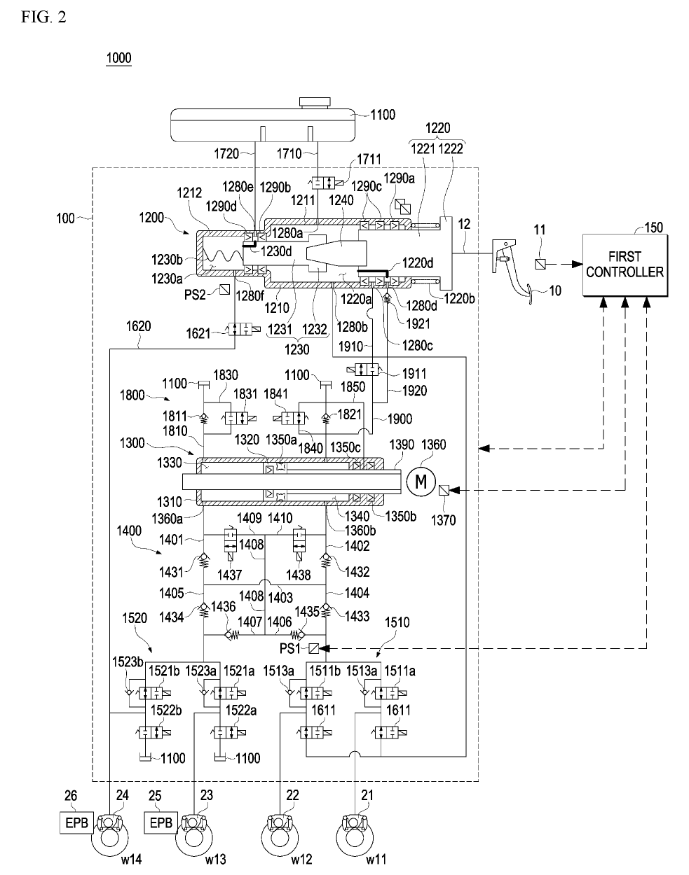

Referring to FIG. 2, the brake module 100 comprises: a reservoir 1100 in which a pressure medium is stored; an integrated master cylinder 1200 that provides reaction force according to pedal force of the brake pedal 55 to the driver while pressurizing and discharging the pressure medium such as brake oil accommodated inside; a hydraulic pressure supply device 1300 that receives the driver's braking intention as an electrical signal through a pedal sensor 11 that detects displacement of the brake pedal 55 and generates hydraulic pressure of the pressure medium through mechanical operation; a hydraulic control unit 1400 that controls hydraulic pressure provided from the hydraulic pressure supply device 1300; a hydraulic circuit 1510, 1520 including wheel cylinders 21, 22, 23, 24 to which hydraulic pressure of the pressure medium is transmitted to perform braking of respective wheels RR, RL, FR, FL; backup passages 1610, 1620 that hydraulically connect the integrated master cylinder 1200 and the hydraulic circuits 1510, 1520; reservoir passages 1710, 1720 that hydraulically connect the reservoir 1100 and the integrated master cylinder 1200; a dump control unit 1800 provided between the hydraulic pressure supply device 1300 and the reservoir 1100 to control flow of the pressure medium; an inspection passage 1900 provided to connect the integrated master cylinder 1200 and the hydraulic pressure supply device 1300 to inspect leak conditions of various component elements; a first controller (ECU) 150 that controls the hydraulic pressure supply device 1300 and various valves based on hydraulic pressure information and pedal displacement information; and a second controller 200 that identifies an abnormal state of the first controller 150 and controls actuation or release of parking brakes 25, 26 provided on at least one of the first axle (front wheels) and second axle (rear wheels) based on an identification result.

The integrated master cylinder 1200 may be provided to provide stable pedal feel by providing reaction force to the driver when the driver applies pedal force to the brake pedal 55 for braking operation, while pressurizing and discharging the pressure medium accommodated inside by operation of the brake pedal 55.

The integrated master cylinder 1200 may have a master cylinder that pressurizes and discharges the pressure medium accommodated inside by pedal force of the brake pedal 55, and a pedal simulator 1240 that provides pedal feel to the driver coaxially arranged within one cylinder body 1210.

The integrated master cylinder 1200 comprises: a cylinder body 1210 that forms a chamber inside; a first master chamber 1220a formed on an inlet side of the cylinder body 1210 where the brake pedal 55 is connected; a first master piston 1220 provided in the first master chamber 1220a and connected to the brake pedal 55 to be displaceable by operation of the brake pedal 55; a second master chamber 1230a formed inside or on a front side (left side in FIG. 2) of the first master chamber 1220a on the cylinder body 1210; a second master piston 1230 provided in the second master chamber 1230a and displaceable by displacement of the first master piston 1220 or hydraulic pressure of the pressure medium accommodated in the first master chamber 1220a; and a pedal simulator 1240 disposed between the first master piston 1220 and the second master piston 1230 to provide pedal feel through elastic restoring force generated during compression.

The first master chamber 1220a and the second master chamber 1230a may be sequentially formed from the brake pedal 55 side (right side in FIG. 2) to the inside (left side in FIG. 2) on the cylinder body 1210 of the integrated master cylinder 1200. Also, the first master piston 1220 and the second master piston 1230 are respectively provided in the first master chamber 1220a and the second master chamber 1230a, and may form hydraulic pressure or negative pressure in the pressure medium accommodated in each chamber according to forward and backward movement.

The cylinder body 1210 may comprise a large diameter portion 1211 in which the first master chamber 1220a is formed inside and which has a relatively large inner diameter, and a small diameter portion 1212 in which the second master chamber 1230a is formed inside and which has a relatively smaller inner diameter than the large diameter portion 1211. The large diameter portion 1211 and small diameter portion 1212 of the cylinder body 1210 may be formed integrally.

The first master chamber 1220a may be formed inside the large diameter portion 1211 which is the inlet side or rear side (right side in FIG. 2) of the cylinder body 1210, and the first master chamber 1220a may accommodated a first master piston 1220 connected to the brake pedal 55 via an input rod 12 for reciprocating movement.

The first master chamber 1220a may have pressure medium flow in and out through a first hydraulic port 1280a, a second hydraulic port 1280b, a third hydraulic port 1280c, and a fourth hydraulic port 1280d. The first hydraulic port 1280a is connected to a first reservoir passage 1710 described later, so that pressure medium may flow from the reservoir 1100 to the first master chamber 1220a or pressure medium accommodated in the first master chamber 1220a may be discharged to the reservoir 1100. The second hydraulic port 1280b is connected to a first backup passage 1610 described later, so that pressure medium may be discharged from the first master chamber 1220a to the first backup passage 1610 side or conversely pressure medium may flow from the first backup passage 1610 to the first master chamber 1220a side.

Also, the first master chamber 1220a is respectively connected to a first branch passage 1910 and a second branch passage 1920 of an inspection passage 1900 described later through the third hydraulic port 1280c and the fourth hydraulic port 1280d, so that pressure medium accommodated in the first master chamber 1220a may be discharged to the inspection passage 1900 side or pressure medium may flow from the inspection passage 1900 to the first master chamber 1220a. A detailed description of this will be provided later.

The first master piston 1220 is accommodated and provided in the first master chamber 1220a, and may form hydraulic pressure by pressurizing the pressure medium accommodated in the first master chamber 1220a by moving forward (leftward direction in FIG. 2), or may form negative pressure inside the first master chamber 1220a by moving backward (rightward direction in FIG. 2). The first master piston 1220 may comprise a first body 1221 formed in a cylindrical shape to closely contact an inner circumferential surface of the first master chamber 1220a, and a first flange 1222 formed to extend radially at a rear end (right end in FIG. 2) of the first body 1221 and to which the input rod 12 is connected. The first master piston 1220 may be elastically supported by a first piston spring 1220b, and the first piston spring 1220b may be provided with one end supported on a front surface (left surface in FIG. 2) of the first flange 1222 and the other end supported on an outer surface of the cylinder body 1210.

The first master piston 1220 may be provided with a first cut-off hole 1220d that communicates with the first master chamber 1220a and simultaneously communicates with the fourth hydraulic port 1280d and the second branch passage 1920 in a non-operating state, that is, in a ready state before displacement occurs. Also, a first sealing member 1290a that seals the first master chamber 1220a from the outside may be provided between an outer circumferential surface of the first master piston 1220 and the cylinder body 1210. The first sealing member 1290a may be provided to be seated in a receiving groove formed recessed on an inner circumferential surface of the cylinder body 1210 and to contact the outer circumferential surface of the first master piston 1220, and may prevent pressure medium accommodated in the first master chamber 1220a from leaking to the outside and simultaneously prevent foreign substances from outside from flowing into the first master chamber 1220a. The first sealing member 1290a may be provided at the outermost side on the inner circumferential surface of the cylinder body 1210, that is, on the rear side (right side in FIG. 2) of the fourth hydraulic port 1280d to which the second branch passage 1920 described later is connected.

A third sealing member 1290c that blocks flow of pressure medium flowing from the first branch passage 1910 connected to the third hydraulic port 1280c to the first master chamber 1220a may be provided between the outer circumferential surface of the first master piston 1220 and the cylinder body 1210. The third sealing member 1290c may be seated in a pair of receiving grooves respectively formed recessed on the front and rear of the third hydraulic port 1280c on the inner circumferential surface of the cylinder body 1210 and may contact the outer circumferential surface of the first master piston 1220. The pair of third sealing members1290c may be provided on the front (left side in FIG. 2) of the first sealing member 1290a, and may allow flow of pressure medium accommodated in the first master chamber 1220a to be transmitted to the first branch passage 1910 through the third hydraulic port 1280c, but may block flow of pressure medium flowing from the first branch passage 1910 to the first master chamber 1220a.

The second master chamber 1230a may be formed inside the small diameter portion 1212 which is the inside or front side (left side in FIG. 2) on the cylinder body 1210, and the second master chamber 1230a may accommodate a second master piston 1230 for reciprocating movement.

The second master chamber 1230a may have pressure medium flow in and out through a fifth hydraulic port 1280e and a sixth hydraulic port 1280f. The fifth hydraulic port 1280e is connected to a second reservoir passage 1720 described later, so that pressure medium accommodated in the reservoir 1100 may flow to the second master chamber 1230a side. Also, the sixth hydraulic port 1280d is connected to a second backup passage 1620 described later, so that pressure medium accommodated in the second master chamber 1230a may be discharged to the second backup passage 1620 side, and conversely pressure medium may flow from the second backup passage 1620 to the second master chamber 1230a side.

The second master piston 1230 is accommodated and provided in the second master chamber 1230a, and may form hydraulic pressure of the pressure medium accommodated in the second master chamber 1230a by moving forward, and may form negative pressure in the second master chamber 1230a by moving backward. The second master piston 1230 may comprise a second body 1231 formed in a cylindrical shape to closely contact an inner circumferential surface of the second master chamber 1230a, and a second flange 1232 formed to extend radially at a rear end (right end in FIG. 2) of the second body 1231 and disposed inside the first master chamber 1220a. A diameter of the second flange 1232 may be formed larger than an inner circumferential surface diameter of the second master chamber 1230a. The second master piston 1230 may be elastically supported by a second piston spring 1230b, and the second piston spring 1230b may be provided with one end supported on a front surface (left surface in FIG. 2) of the second body 1231 and the other end supported on an inner surface of the cylinder body 1210.

A second sealing member 1290b that seals the first master chamber 1220a with respect to the second master chamber 1230a may be provided between an outer circumferential surface of the second master piston 1230 and the cylinder body 1210. The second sealing member 1290b may be provided to be seated in a receiving groove formed recessed on an inner circumferential surface of the cylinder body 1210 and to contact the outer circumferential surface of the second master piston 1230, and may prevent pressure medium accommodated in the first master chamber 1220a from leaking to the second master chamber 1230a.

The second master piston 1230 is provided with a second cut-off hole 1230d that communicates with the second master chamber 1230a and simultaneously communicates with the fifth hydraulic port 1280e and the second reservoir passage 1720 in a non-operating state, that is, in a ready state before displacement occurs. Also, a fourth sealing member 1290d that blocks flow of pressure medium discharged from the second master chamber 1230a to the second reservoir passage 1720 connected to the fifth hydraulic port 1280e may be provided between the outer circumferential surface of the second master piston 1230 and the cylinder body 1210. The fourth sealing member 1290d may be seated in a receiving groove formed recessed on the front (left side in FIG. 2) of the fifth hydraulic port 1280e on the inner circumferential surface of the cylinder body 1210 and may contact the outer circumferential surface of the second master piston 1230. The fourth sealing member 1290d may be provided on the front (left side in FIG. 2) of the second sealing member 1290b, and may allow flow of pressure medium transmitted from the second reservoir passage 1720 connected to the fifth hydraulic port 1280e to the second master chamber 1230a, but may block flow of pressure medium transmitted from the second master chamber 1230a to the fifth hydraulic port 1280e and the second reservoir passage 1720.

The integrated master cylinder 1200 may secure safety in case of failure of component elements by independently providing the first master chamber 1220a and the second master chamber 1230a. For example, the first master chamber 1220a is connected to any two wheel cylinders 21, 22 through a first backup passage 1610 described later, and the second master chamber 1230a may be connected to the other two wheel cylinders 23, 24 through a second backup passage 1620 described later, so that even when a problem such as leak occurs in any one chamber, vehicle braking may be possible.

The pedal simulator 1240 is provided between the first master piston 1220 and the second master piston 1230, and may provide pedal feel of the brake pedal 55 to the driver by its own elastic restoring force.

The pedal simulator 1240 may be interposed between a front surface of the first master piston 1220 and a rear surface of the second master piston 1230, and may be made of an elastic material such as rubber that can be compressed and expanded. The pedal simulator 1240 may comprise a cylindrical body portion having at least a portion inserted and supported in a front surface of the first master piston 1220, and a taper portion having at least a portion inserted and supported in a rear surface of the second master piston 1230 and having a diameter that gradually decreases toward the front (left side in FIG. 2). At least portions of both ends of the pedal simulator 1240 may be respectively inserted into the first master piston 1220 to be stably supported. Furthermore, the taper portion may provide stable and familiar pedal feel to the driver by changing elastic restoring force according to the degree of pedal force of the brake pedal 55.

Describing pedal simulation operation by the integrated master cylinder 1200, in a normal operation mode, when the driver operates the brake pedal 55, a first cut valve 1611 and a second cut valve 1621 respectively provided in a first backup passage 1610 and a second backup passage 1620 described later are closed, while a simulator valve 1711 of a first reservoir passage 1710 is opened. As operation of the brake pedal 55 proceeds, the first master piston 1220 moves forward, but as the second cut valve 1621 operates to close, the second master chamber 1230a is sealed so that the second master piston 1230 cannot be displaced. At this time, by closing operation of the first cut valve 1611 and opening operation of the simulator valve 1711, pressure medium accommodated in the first master chamber 1220a may flow along the first reservoir passage 1710. While the second master piston 1230 cannot move forward, as the first master piston 1220 continues to move forward, the pedal simulator 1240 is compressed, and elastic restoring force of the pedal simulator 1240 may be provided to the driver as pedal feel. After this, when the driver releases pedal force of the brake pedal 55, the first master piston 1220 and second master piston 1230 and the pedal simulator 1240 return to their original form and position by elastic restoring force of the first piston spring 1220b and second piston spring 1230b and the pedal simulator 1240, and the first master chamber 1220a may be filled with pressure medium supplied from the reservoir 1100 through the first reservoir passage 1710.

As described above, since the insides of the first master chamber 1220a and second master chamber 1230a are always filled with pressure medium, friction between the first master piston 1220 and second master piston 1230 is minimized during pedal simulation operation, improving durability of the integrated master cylinder 1200 as well as blocking inflow of foreign substances from the outside.

The reservoir 1100 may accommodate and store pressure medium inside. The reservoir 1100 may be connected to the integrated master cylinder 1200, the hydraulic pressure supply device 1300 described later, and the hydraulic circuit, etc., to supply or receive pressure medium. Although several reservoirs 1100 are shown with the same reference numeral in the drawing, this is an example to help understanding of the invention, and the reservoir 1100 may be provided as a single component or as a plurality of separate independent components.

The reservoir passage 1700 may be provided to connect the integrated master cylinder 1200 and the reservoir 1100.

The reservoir passage 1700 may comprise a first reservoir passage 1710 connecting the first master chamber 1220a and the reservoir 1100, and a second reservoir passage 1720 connecting the second master chamber 1230a and the reservoir 1100. For this, one end of the first reservoir passage 1710 communicates with the first master chamber 1220a by the first hydraulic port 1280a of the integrated master cylinder 1200, and the other end may communicate with the reservoir 1100, and one end of the second reservoir passage 1720 communicates with the second master chamber 1230a by the fifth hydraulic port 1280e of the integrated master cylinder 1200, and the other end may communicate with the reservoir 1100. Also, as described above, a simulator valve 1711 that operates to open in normal operation mode is provided in the first reservoir passage 1710, so that flow of pressure medium between the reservoir 1100 and the first master chamber 1220a through the first reservoir passage 1710 may be controlled.

The hydraulic pressure supply device 1300 may be provided to generate hydraulic pressure of the pressure medium through mechanical operation by receiving the driver's braking intention as an electrical signal from the pedal sensor 50 that detects displacement of the brake pedal 55.

The hydraulic pressure supply device 1300 is provided to generate hydraulic pressure of the pressure medium through mechanical operation by receiving the driver's braking intention as an electrical signal from the pedal sensor 50 that detects displacement of the brake pedal 55.

The hydraulic pressure supply device 1300 may comprise a hydraulic pressure providing unit that provides pressure medium pressure transmitted to the plurality of wheel cylinders 21, 22, 23, 24, a motor (not shown) that generates rotational force by an electrical signal of the pedal sensor 50, and a power conversion unit (not shown) that converts rotational motion of the motor into linear motion and transmits it to the hydraulic pressure providing unit.

The hydraulic pressure providing unit of the hydraulic pressure supply device 1300 comprises a cylinder block 1310 provided to accommodate pressure medium, a hydraulic piston 1320 accommodated in the cylinder block 1310, a single pressure chamber 1330 whose volume changes by operation of the hydraulic piston 1320, and a drive shaft 1390 that transmits power output from the power conversion unit to the hydraulic piston 1320.

The pressure chambers 1330, 1340 may comprise a first pressure chamber 1330 located on the front (left direction of the hydraulic piston 1320 in FIG. 2) of the hydraulic piston 1320, and a second pressure chamber 1340 located on the rear (right direction of the hydraulic piston 1320 in FIG. 2) of the hydraulic piston 1320. That is, the first pressure chamber 1330 is partitioned and provided by the cylinder block 1310 and a front surface of the hydraulic piston 1320 so that its volume changes according to movement of the hydraulic piston 1320, and the second pressure chamber 1340 is partitioned and provided by the cylinder block 1310 and a rear surface of the hydraulic piston 1320 so that its volume changes according to movement of the hydraulic piston 1320.

The first pressure chamber 1330 may be connected to a first hydraulic passage 1401 described later through a first communication hole 1360a formed in the cylinder block 1310, and the second pressure chamber 1340 may be connected to a second hydraulic passage 1402 described later through a second communication hole 1360b formed in the cylinder block 1310.

The sealing member comprises a piston sealing member 1350a provided between the hydraulic piston 1320 and the cylinder block 1310 to seal between the first pressure chamber 1330 and the second pressure chamber 1340, and a drive shaft sealing member 1350b provided between the drive shaft 1390 and the cylinder block 1310 to seal between the second pressure chamber 1340 and an opening of the cylinder block 1310. Hydraulic pressure or negative pressure of the first pressure chamber 1330 and second pressure chamber 1340 generated by forward or backward movement of the hydraulic piston 1320 may be sealed by the piston sealing member 1350a and drive shaft sealing member 1350b without leaking and transmitted to the first hydraulic passage 1401 and second hydraulic passage 1402 described later. Also, a chamber sealing member 1350c may be provided between the second pressure chamber 1340 and the drive shaft sealing member 1350b, and the chamber sealing member 1350c may allow flow of pressure medium flowing into the second pressure chamber 1340 through an auxiliary inflow passage 1850 described later, but may block flow of pressure medium leaking from the second pressure chamber 1340 to the auxiliary inflow passage 1850.

The motor 1360 is provided to generate driving force of the hydraulic piston 1320 by an electrical signal output from the first controller 150. The motor 1360 may be provided including a stator and a rotor, and may provide power to generate displacement of the hydraulic piston 1320 by rotating in forward or reverse direction. Rotational angular velocity and rotation angle of the motor 1360 may be precisely controlled by a motor control sensor (not shown). Since the motor 1360 is already widely known technology, detailed description will be omitted.

The power conversion unit of the hydraulic pressure supply device 1300 may be provided to convert rotational force of the motor 1360 into linear motion. The power conversion unit may be provided as a structure including, for example, a worm shaft (not shown), a worm wheel (not shown), and a drive shaft 1390.

The worm shaft may be formed integrally with a rotation shaft of the motor 1360, and a worm may be formed on an outer circumferential surface to engage with the worm wheel and rotate the worm wheel. The worm wheel may be connected to engage with the drive shaft 1390 to linearly move the drive shaft 1390, and the drive shaft 1390 is connected to the hydraulic piston 1320 to operate integrally, so that the hydraulic piston 1320 may be sliding moved within the cylinder block 1310.

Describing the above operations again, when displacement is detected in the brake pedal 55 by the pedal sensor 11, the detected signal is transmitted to the first controller 150, and the first controller 150 may drive the motor 1360 to rotate the worm shaft in one direction. Rotational force of the worm shaft is transmitted to the drive shaft 1390 via the worm wheel, and the hydraulic piston 1320 connected to the drive shaft 1390 moves forward within the cylinder block 1310 to generate hydraulic pressure in the pressure chamber 1330.

Conversely, when pedal force of the brake pedal 55 is released, the first controller 150 drives the motor 1360 to rotate the worm shaft in the opposite direction. Therefore, the worm wheel also rotates in the opposite direction, and the hydraulic piston 1320 connected to the drive shaft 1390 moves backward within the cylinder block 1310 to generate negative pressure in the pressure chamber 1330.

Generation of hydraulic pressure and negative pressure of the second pressure chamber 1340 may be implemented by operating in the opposite direction to the above. That is, when displacement is detected in the brake pedal 55 by the pedal sensor 11, the detected signal is transmitted to the first controller 150, and the first controller 150 may drive the motor 1360 to rotate the worm shaft in the opposite direction. Rotational force of the worm shaft is transmitted to the drive shaft 1390 via the worm wheel, and the hydraulic piston 1320 connected to the drive shaft 1390 moves backward within the cylinder block 1310 to generate hydraulic pressure in the second pressure chamber 1340.

Conversely, when pedal force of the brake pedal 55 is released, the first controller 150 may drive the motor 1360 in one direction to rotate the worm shaft in one direction. Therefore, the worm wheel also rotates in reverse, and the hydraulic piston 1320 connected to the drive shaft 1390 moves forward within the cylinder block 1310 to generate negative pressure in the second pressure chamber 1340.

As described above, the hydraulic pressure supply device 1300 may generate hydraulic pressure or negative pressure in the first pressure chamber 1330 and second pressure chamber 1340 according to the rotation direction of the worm shaft by driving the motor 1360. Whether to transmit hydraulic pressure to implement braking or to use negative pressure to release braking may be determined by controlling valves. A detailed description of this will be provided later.

Meanwhile, the power conversion unit according to this embodiment is not limited to any one structure as long as it can convert rotational motion of the motor 1360 into linear motion of the hydraulic piston 1320, and should be understood equally even when composed of devices of various structures and methods.

The hydraulic pressure supply device 1300 may be hydraulically connected to the reservoir 1100 by the dump control unit 1800. The dump control unit 1800 may comprise a first dump control unit that controls flow of pressure medium between the first pressure chamber 1330 and the reservoir 1100, and a second dump control unit that controls flow of pressure medium between the second pressure chamber 1340 and the reservoir 1100. The first dump control unit comprises a first dump passage 1810 connecting the first pressure chamber 1330 and the reservoir 1100, and a first bypass passage 1830 that branches from and rejoins the first dump passage 1810, and the second dump control unit comprises a second dump passage 1820 connecting the second pressure chamber 1340 and the reservoir 1100, and a second bypass passage 1840 that branches from and rejoins the second dump passage 1820.

A first dump check valve 1811 and a first dump valve 1831 that control flow of pressure medium may be respectively provided in the first dump passage 1810 and first bypass passage 1830. The first dump check valve 1811 may be provided to allow only flow of pressure medium from the reservoir 1100 toward the first pressure chamber 1330 and block flow of pressure medium in the opposite direction. A first bypass passage 1830 is connected in parallel to the first dump check valve 1811 on the first dump passage 1810, and a first dump valve 1831 that controls flow of pressure medium between the first pressure chamber 1330 and the reservoir 1100 may be provided in the first bypass passage 1830. In other words, the first bypass passage 1830 may connect front and rear ends of the first dump check valve 1811 by bypassing on the first dump passage 1810, and the first dump valve 1831 may be provided as a bidirectional solenoid valve that controls flow of pressure medium between the first pressure chamber 1330 and the reservoir 1100. The first dump valve 1831 may be provided as a normally closed type solenoid valve that is normally in a closed state and operates to open when receiving an electrical signal from the first controller 150.

A second dump check valve 1821 and a second dump valve 1841 that control flow of pressure medium may be respectively provided in the second dump passage 1820 and second bypass passage 1840. The second dump check valve 1821 may be provided to allow only flow of pressure medium from the reservoir 1100 toward the second pressure chamber 1340 and block flow of pressure medium in the opposite direction. A second bypass passage 1840 is connected in parallel to the second dump check valve 1821 on the second dump passage 1820, and a second dump valve 1841 that controls flow of pressure medium between the second pressure chamber 1340 and the reservoir 1100 may be provided in the second bypass passage 1840. In other words, the second bypass passage 1840 may connect front and rear ends of the second dump check valve 1821 by bypassing on the second dump passage 1820, and the second dump valve 1841 may be provided as a bidirectional solenoid valve that controls flow of pressure medium between the second pressure chamber 1340 and the reservoir 1100. The second dump valve 1841 may be provided as a normally open type solenoid valve that is normally open and operates to close when receiving an electrical signal from the first controller 150.

Also, the dump control unit 1800 may comprise an auxiliary inflow passage 1850 connecting the reservoir 1100 and the second pressure chamber 1340 so that pressure medium may be filled in the second pressure chamber 1340. The auxiliary inflow passage 1850 may be connected to the rear (right side in FIG. 2) of the chamber sealing member 1350c on the cylinder body 1210. Thereby, pressure medium may flow from the reservoir 1100 to the second pressure chamber 1340 through the auxiliary inflow passage 1850, but flow of pressure medium leaking from the second pressure chamber 1340 to the auxiliary inflow passage 1850 may be blocked by the chamber sealing member 1350c.

The hydraulic control unit 1400 may be provided to control flow of pressure medium directed to each wheel cylinder 21, 22, 23, 24 or flow of pressure medium recovered from each wheel cylinder 21, 22, 23, 24 to the hydraulic pressure supply device 1300.

For this, the hydraulic control unit 1400 may comprise a plurality of passages and a plurality of valves that can allow or block flow of pressure medium in the plurality of passages to smoothly control flow or hydraulic pressure of pressure medium.

Specifically, the hydraulic control unit 1400 may comprise a first hydraulic circuit 1510 that controls flow of hydraulic pressure transmitted to the first wheel cylinder 21 and second wheel cylinder 22 among the four wheel cylinders 21, 22, 23, 24, and a second hydraulic circuit 1520 that controls flow of hydraulic pressure transmitted to the third wheel cylinder 23 and fourth wheel cylinder 24, and may comprise a plurality of passages and valves to control hydraulic pressure transmitted from the hydraulic pressure supply device 1300 to the wheel cylinders 21, 22, 23, 24.

The first hydraulic passage 1401 is provided to communicate with the first pressure chamber 1330, and the second hydraulic passage 1402 may be provided to communicate with the second pressure chamber 1340. The first hydraulic passage 1401 and second hydraulic passage 1402 merge into a third hydraulic passage 1403 and then may be provided to branch again into a fourth hydraulic passage 1404 connected to the first hydraulic circuit 1510 and a fifth hydraulic passage 1405 connected to the second hydraulic circuit 1520.

A sixth hydraulic passage 1406 is provided to communicate with the first hydraulic circuit 1510, and a seventh hydraulic passage 1407 may be provided to communicate with the second hydraulic circuit 1520. The sixth hydraulic passage 1406 and seventh hydraulic passage 1407 merge into an eighth hydraulic passage 1408 and then may be provided to branch again into a ninth hydraulic passage 1409 communicating with the first pressure chamber 1330 and a tenth hydraulic passage 1410 communicating with the second pressure chamber 1340.

A first valve 1431 that controls flow of pressure medium may be provided in the first hydraulic passage 1401. The first valve 1431 may be provided as a check valve that allows flow of pressure medium discharged from the first pressure chamber 1330 but blocks flow of pressure medium in the opposite direction. Also, a second valve 1432 that controls flow of pressure medium may be provided in the second hydraulic passage 1402, and the second valve 1432 may be provided as a check valve that allows flow of pressure medium discharged from the second pressure chamber 1340 but blocks flow of pressure medium in the opposite direction.

The fourth hydraulic passage 1404 may be provided to branch again from the third hydraulic passage 1403 where the first hydraulic passage 1401 and second hydraulic passage 1402 merge and connect to the first hydraulic circuit 1510. A third valve 1433 that controls flow of pressure medium may be provided in the fourth hydraulic passage 1404. The third valve 1433 may be provided as a check valve that allows only flow of pressure medium from the third hydraulic passage 1403 toward the first hydraulic circuit 1510 and blocks flow of pressure medium in the opposite direction.

The fifth hydraulic passage 1405 may be provided to branch again from the third hydraulic passage 1403 where the first hydraulic passage 1401 and second hydraulic passage 1402 merge and connect to the second hydraulic circuit 1520. A fourth valve 1434 that controls flow of pressure medium may be provided in the fifth hydraulic passage 1405. The fourth valve 1434 may be provided as a check valve that allows only flow of pressure medium from the third hydraulic passage 1403 toward the second hydraulic circuit 1520 and blocks flow of pressure medium in the opposite direction.

The sixth hydraulic passage 1406 communicates with the first hydraulic circuit 1510, the seventh hydraulic passage 1407 communicates with the second hydraulic circuit 1520, and they may be provided to merge into the eighth hydraulic passage 1408. A fifth valve 1435 that controls flow of pressure medium may be provided in the sixth hydraulic passage 1406. The fifth valve 1435 may be provided as a check valve that allows only flow of pressure medium discharged from the first hydraulic circuit 1510 and blocks flow of pressure medium in the opposite direction. Also, a sixth valve 1436 that controls flow of pressure medium may be provided in the seventh hydraulic passage 1407. The sixth valve 1436 may be provided as a check valve that allows only flow of pressure medium discharged from the second hydraulic circuit 1520 and blocks flow of pressure medium in the opposite direction.

The ninth hydraulic passage 1409 may be provided to branch from the eighth hydraulic passage 1408 where the sixth hydraulic passage 1406 and seventh hydraulic passage 1407 merge and connect to the first pressure chamber 1330. A seventh valve 1437 that controls flow of pressure medium may be provided in the ninth hydraulic passage 1409. The seventh valve 1437 may be provided as a bidirectional control valve that controls flow of pressure medium transmitted along the ninth hydraulic passage 1409. The seventh valve 1437 may be provided as a normally closed type solenoid valve that is normally in a closed state and operates to open when receiving an electrical signal from the first controller 150.

The tenth hydraulic passage 1410 may be provided to branch from the eighth hydraulic passage 1408 where the sixth hydraulic passage 1406 and seventh hydraulic passage 1407 merge and connect to the second pressure chamber 1340. An eighth valve 1438 that controls flow of pressure medium may be provided in the tenth hydraulic passage 1410. The eighth valve 1438 may be provided as a bidirectional control valve that controls flow of pressure medium transmitted along the tenth hydraulic passage 1410. The eighth valve 1438, like the seventh valve 1437, may be provided as a normally closed type solenoid valve that is normally in a closed state and operates to open when receiving an electrical signal from the first controller 150.

According to the plurality of hydraulic passages and plurality of valves described above, hydraulic pressure formed in the first pressure chamber 1330 by forward movement of the hydraulic piston 1320 may be transmitted to the first hydraulic circuit 1510 sequentially through the first hydraulic passage 1401, third hydraulic passage 1403, and fourth hydraulic passage 1404, and may be transmitted to the second hydraulic circuit 1520 sequentially through the first hydraulic passage 1401 and fifth hydraulic passage 1405. Also, hydraulic pressure formed in the second pressure chamber 1340 by backward movement of the hydraulic piston 1320 may be transmitted to the first hydraulic circuit 1510 sequentially through the second hydraulic passage 1402 and fourth hydraulic passage 1404, and may be transmitted to the second hydraulic circuit 1520 sequentially through the second hydraulic passage 1402, third hydraulic passage 1403, and fifth hydraulic passage 1405.

Conversely, negative pressure formed in the first pressure chamber 1330 by backward movement of the hydraulic piston 1320 may allow pressure medium provided to the first hydraulic circuit 1510 to be recovered to the first pressure chamber 1330 sequentially through the sixth hydraulic passage 1406, eighth hydraulic passage 1408, and ninth hydraulic passage 1409, and may allow pressure medium provided to the second hydraulic circuit 1520 to be recovered to the first pressure chamber 1330 sequentially through the seventh hydraulic passage 1407, eighth hydraulic passage 1408, and ninth hydraulic passage 1409. Also, negative pressure formed in the second pressure chamber 1340 by forward movement of the hydraulic piston 1320 may allow pressure medium provided to the first hydraulic circuit 1510 to be recovered to the first pressure chamber 1340 sequentially through the sixth hydraulic passage 1406, eighth hydraulic passage 1408, and tenth hydraulic passage 1410, and may allow pressure medium provided to the second hydraulic circuit 1520 to be recovered to the second pressure chamber 1340 sequentially through the seventh hydraulic passage 1407, eighth hydraulic passage 1408, and tenth hydraulic passage 1410.

The first hydraulic circuit 1510 of the hydraulic control unit 1400 adjusts and/or controls hydraulic pressure of the first wheel cylinder 21 and second wheel cylinder 22 among the four wheel cylinders 21, 22, 23, 24, and the second hydraulic circuit 1520 may adjust and/or control hydraulic pressure of the third wheel cylinder 23 and fourth wheel cylinder 24 among the four wheel cylinders 21, 22, 23, 24.

The first hydraulic circuit 1510 may receive hydraulic pressure through the fourth hydraulic passage 1404 and discharge hydraulic pressure through the sixth hydraulic passage 1406. For this, as shown in FIG. 2, the fourth hydraulic passage 1404 and sixth hydraulic passage 1406 may be provided to merge and then branch into two passages connected to the first wheel cylinder 21 and second wheel cylinder 22. Also, the second hydraulic circuit 1520 may receive hydraulic pressure through the fifth hydraulic passage 1405 and discharge hydraulic pressure through the seventh hydraulic passage 1407, and accordingly, as shown in FIG. 2, the fifth hydraulic passage 1405 and seventh hydraulic passage 1407 may be provided to merge and then branch into two passages connected to the third wheel cylinder 23 and fourth wheel cylinder 24. However, the connection of hydraulic passages shown in FIG. 2 is an example to help understanding of the present invention and is not limited to that structure, and the fourth hydraulic passage 1404 and sixth hydraulic passage 1406 may be respectively connected to the first hydraulic circuit 1510 side and independently branch to connect to the first wheel cylinder 21 and second wheel cylinder 22. Similarly, the fifth hydraulic passage 1405 and seventh hydraulic passage 1407 may be respectively connected to the second hydraulic circuit 1520 side and independently branch to connect to the third wheel cylinder 23 and fourth wheel cylinder 24, and should be understood equally even when connected in various methods and structures.

The first hydraulic circuit 1510 and second hydraulic circuit 1520 may respectively comprise first through fourth inlet valves 1511a, 1511b, 1521a, 1521b to control flow and hydraulic pressure of pressure medium transmitted to the first through fourth wheel cylinders 21, 22, 23, 24. The first through fourth inlet valves 1511a, 1511b, 1521a, 1521b are respectively disposed upstream of the first through fourth wheel cylinders 21, 22, 23, 24 and may be provided as normally open type solenoid valves that are normally open and operate to close when receiving an electrical signal from the first controller 150.

The first hydraulic circuit 1510 and second hydraulic circuit 1520 may comprise first through fourth check valves 1513a, 1513b, 1523a, 1523b connected in parallel to the first through fourth inlet valves 1511a, 1511b, 1521a, 1521b. Each of the first through fourth check valves 1513a, 1513b, 1523a, 1523b may be provided in bypass passages connecting front and rear of the first through fourth inlet valves 1511a, 1511b, 1521a, 1521b on the first hydraulic circuit 1510 and second hydraulic circuit 1520, and may allow only flow of pressure medium from the first through fourth wheel cylinders 21, 22, 23, 24 to the hydraulic pressure supply device 1300 and block flow of pressure medium from the hydraulic pressure supply device 1300 to the first through fourth wheel cylinders 21, 22, 23, 24. The first through fourth check valves 1513a, 1513b, 1523a, 1523b may quickly extract hydraulic pressure of pressure medium applied to each of the first through fourth wheel cylinders 21, 22, 23, 24, and even when the first through fourth inlet valves 1511a, 1511b, 1521a, 1521b do not operate normally, hydraulic pressure of pressure medium applied to each of the first through fourth wheel cylinders 21, 22, 23, 24 may smoothly return to the hydraulic pressure providing unit.

The second hydraulic circuit 1520 may comprise first and second outlet valves 1522a, 1522b that control flow of pressure medium discharged from the third wheel cylinder 23 and fourth wheel cylinder 24 for performance improvement during brake release. The first outlet valve 1522a and second outlet valve 1522b are respectively provided on discharge sides of the third wheel cylinder 23 and fourth wheel cylinder 24 to control flow of pressure medium transmitted from the third wheel cylinder 23 and fourth wheel cylinder 24 to the reservoir 1100. The first outlet valve 1522a and second outlet valve 1522b may be provided as normally closed type solenoid valves that are normally in a closed state and operate to open when receiving an electrical signal from the first controller 150. The first outlet valve 1522a and second outlet valve 1522b may selectively release hydraulic pressure of pressure medium applied to the third wheel cylinder 23 and fourth wheel cylinder 22 during ABS braking mode of the vehicle to transmit to the reservoir 1100 side.

The first wheel cylinder 21 and second wheel cylinder 22 of the first hydraulic circuit 1510 may have a first backup passage 1610 described later branch and connect, and at least one first cut valve 1611 may be provided in the first backup passage 1610 to control flow of pressure medium between the first wheel cylinder 21 and second wheel cylinder 22 and the integrated master cylinder 1200.

The electronic brake system 1000 according to the first embodiment of the present invention may comprise a first backup passage 1610 and a second backup passage 1620 to implement braking by directly supplying pressure medium discharged from the integrated master cylinder 1200 to the wheel cylinders 21, 22, 23, 24 when normal operation is impossible due to device failure, etc. A mode in which hydraulic pressure of the integrated master cylinder 1200 is directly transmitted to the wheel cylinders 21, 22, 23, 24 is called an abnormal operation mode, that is, a fallback mode.

The first backup passage 1610 may be provided to connect the first master chamber 1220a of the integrated master cylinder 1200 and the first hydraulic circuit 1510, and the second backup passage 1620 may be provided to connect the second master chamber 1230a of the integrated master cylinder 1200 and the second hydraulic circuit 1520.

The first backup passage 1610 may have one end connected to the first master chamber 1220a and the other end branch connected to the downstream side of the first inlet valve 1511a and second inlet valve 1511b on the first hydraulic circuit 1510, and the second backup passage 1620 may have one end connected to the second master chamber 1230a and the other end connected between the third inlet valve 1521a and first outlet valve 1522a on the second hydraulic circuit 1520.

Although FIG. 2 shows the second backup passage 1620 connected between the third inlet valve 1521a and first outlet valve 1522a, the second backup passage 1620 should be understood equally if it branches to connect to at least any one of the upstream sides of the first outlet valve 1522a and second outlet valve 1522b.

At least one first cut valve 1611 that controls bidirectional flow of pressure medium is provided in the first backup passage 1610, and a second cut valve 1621 that controls bidirectional flow of pressure medium may be provided in the second backup passage 1620. The first cut valve 1611 and second cut valve 1621 may be provided as normally open type solenoid valves that are normally open and operate to close when receiving a closing signal from the first controller 150.

The first cut valve 1611 may be provided as a pair respectively on the first and second wheel cylinder 21, 22 sides as shown in FIG. 2, and may selectively release hydraulic pressure of pressure medium applied to the first wheel cylinder 21 and second wheel cylinder 22 during ABS braking mode of the vehicle to discharge to the reservoir 1100 side through the first backup passage 1610, first master chamber 1220a, second branch passage 1920 described later, and dump control unit 1800. A detailed description of this will be provided later.

When closing the first cut valve 1611 and second cut valve 1621, it is possible to prevent pressure medium of the integrated master cylinder 1200 from being directly transmitted to the wheel cylinder 20 and simultaneously prevent hydraulic pressure provided from the hydraulic pressure supply device 1300 from leaking to the integrated master cylinder 1200 side.

Also, when opening the first cut valve 1611 and second cut valve 1621, pressure medium pressurized in the integrated master cylinder 1200 may be directly supplied to the first hydraulic circuit 1510 and second hydraulic circuit 1520 sides through the first backup passage 1610 and second backup passage 1620 to implement braking.

The inspection passage 1900 is provided to connect the integrated master cylinder 1200 and hydraulic pressure supply device 1300 and may be provided to inspect leak conditions of various component elements mounted in the integrated master cylinder 1200 and the simulator valve 1711.

The inspection passage 1900 may have one end connected to the second pressure chamber 1340 and the other end branch into a first branch passage 1910 and second branch passage 1920 to respectively connect to the first master chamber 1220a through the third hydraulic port 1280c and fourth hydraulic port 1280d. One end of the inspection passage 1900 may be directly connected to the second pressure chamber 1340 or may be connected to the second pressure chamber 1340 via the second dump passage 1820 as shown in FIG. 2.

An inspection valve 1911 that controls bidirectional flow of pressure medium between the first master chamber 1220a and second pressure chamber 1340 is provided in the first branch passage 1910, and an inspection check valve 1921 that allows only flow of pressure medium from the first master chamber 1220a toward the second pressure chamber 1340 and blocks flow of pressure medium in the opposite direction may be provided in the second branch passage 1920. The inspection valve 1911 may be provided as a normally open type solenoid valve that is normally open and operates to close when receiving an electrical signal from the first controller 150. The inspection valve 1911 may be controlled to a closed state in a first inspection mode of the electronic brake system 1000 and controlled to an open state in a second inspection mode. A detailed description of this will be provided later.

The electronic brake system 1000 may comprise a circuit pressure sensor PS1 that detects hydraulic pressure of pressure medium provided by the hydraulic pressure supply device 1300, and a cylinder pressure sensor PS2 that detects hydraulic pressure of the second master chamber 1230a.

The circuit pressure sensor PS1 is provided on the first hydraulic circuit 1510 side and may detect hydraulic pressure of pressure medium generated and provided from the hydraulic pressure supply device 1300 and transmitted to the first hydraulic circuit 1510 during inspection mode. For example, the circuit pressure sensor PS1 may be provided on the fourth hydraulic passage 1404.

The cylinder pressure sensor PS2 is provided between the second master chamber 1230a and second cut valve 1621 on the second backup passage 1620 and may detect hydraulic pressure of pressure medium accommodated in the second master chamber 1230a.

Pressure value information of pressure medium detected by at least one of the circuit pressure sensor PS1 and cylinder pressure sensor PS2 may be transmitted to the first controller 150. For example, during a braking inspection mode described later, pressure value information of pressure medium detected by the circuit pressure sensor PS1 may be transmitted to the first controller 150.

The first controller 150 may determine leak conditions of the integrated master cylinder 1200 or simulator valve 1711 by comparing hydraulic pressure values detected by the circuit pressure sensor PS1 and hydraulic pressure values detected by the cylinder pressure sensor PS2.

Also, the brake module 100 may comprise a motor position sensor 1370 that detects a rotational position of the motor 1360 of the hydraulic pressure supply device 1300. For example, during braking inspection mode, rotational position information of the motor 1360 detected by the motor position sensor 1370 may be transmitted to the first controller 150. Here, the first controller 150 of the brake module 100 may operate the motor 1360 of the hydraulic pressure supply device 1300 based on target braking pressure to generate hydraulic pressure, and at this time may measure hydraulic pressure provided to each wheel cylinder 21, 22, 23, 24. The first controller 150 may know the operation amount (stroke distance, rotational position, etc.) of the motor 1360 based on output signals of the motor position sensor 1370, and may know pressure applied to each wheel cylinder 21, 22, 23, 24.

The first controller 150 may comprise a plurality of semiconductor elements and may be variously named such as an electronic control unit (ECU). The first controller 150 may comprise, for example, one or more first processors 151 and one or more first memories 152.

The first controller 150 may receive signals corresponding to the user's braking intention from the pedal sensor 11, and in response to this, may respectively provide electrical signals for supplying or recovering hydraulic pressure to each wheel cylinder 21, 22, 23, 24 to the hydraulic pressure supply device 1300 and hydraulic control unit 1400.

The first memory 152 may store or remember programs and data for implementing operations to control components comprised in the electronic brake system 1000.

The first memory 152 may provide stored programs and data to the first processor 151 and may remember temporary data generated during operation of the first processor 151. For example, the first memory 152 may comprise volatile memory such as S-RAM (Static Random Access Memory) and D-RAM (Dynamic Random Access Memory), and non-volatile memory such as ROM (Read Only Memory), EPROM (Erasable Programmable Read Only Memory), and flash memory.

The second controller 200 may be provided to identify an abnormal state of the first controller 150 and control operation of the motor 30 of the parking brakes 25, 26 based on an identification result.

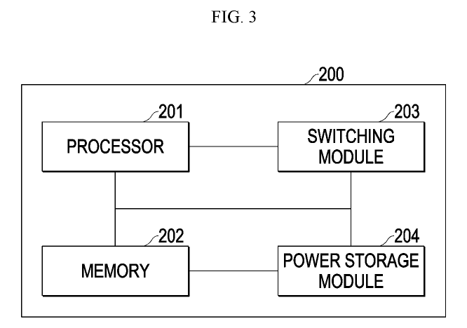

FIG. 3 is a diagram showing a configuration of a second controller of an electronic brake system according to an embodiment of the disclosed invention.

Referring to FIG. 3, the second controller 200 may comprise a second processor 201 that identifies an abnormal state of the first controller 150, a second memory 202 that provides stored programs and data to the second processor 201, and a switching module 203 that controls power supply to the motor 30 based on control by the second processor 201.

The second processor 201 may receive status information from the first controller 150 to monitor abnormal states. Here, the abnormal state of the first controller 150 may appear in various forms. Specifically, the abnormal state may include complete power failure of the first controller 150, communication disconnection between the first controller 150 and second controller 200, software crash or freeze of the first controller 150, hardware defects detected within the first controller 150, or cases where the first controller 150 does not respond to periodic heartbeat or watchdog signals from the second controller 200, but is not limited thereto. For example, the second processor 201 may detect information about power cutoff from the power supply unit 90 or abnormality occurrence in the brake module 100 based on status information received from the first controller 150, and may identify an abnormal state of the first controller 150 based on detection results. Also, the second processor 201 may continuously monitor the state of the first controller 150, and when the first controller 150 is in a normal state, may maintain bypass connection with the motor 30, and when an abnormality occurs in the first controller 150, may perform independent control. If a communication abnormality occurs between the first controller 150 and second controller 200, the second controller 200 may receive status information of the first controller 150 through bypass via an external other control unit (not shown).

The second memory 202 may store or remember programs and data for implementing operations to control components comprised in the second controller 200.

The second memory 202 may provide stored programs and data to the second processor 201 and may remember temporary data generated during operation of the second processor 201. For example, the second memory 202 may comprise volatile memory such as S-RAM (Static Random Access Memory) and D-RAM (Dynamic Random Access Memory), and non-volatile memory such as ROM (Read Only Memory), EPROM (Erasable Programmable Read Only Memory), and flash memory.

The switching module 203 may maintain bypass connection between the first controller 150 and motor 30 based on control by the second processor 201 when the first controller 150 is in a normal state. Conversely, when the first controller 150 is in an abnormal state, the switching module 203 may open the bypass connection between the first controller 150 and motor 30 based on control by the second processor 201, and may control power supply for operation of the motor 30 using internal switching elements 211, 212, 221, 222.

The switching module 203 may comprise at least one switching element 211, 212, 221, 222 that controls connection between the first controller 150 and motor 30 or between the power supply unit 90 and motor 30. The switching elements 211, 212, 221, 222 may comprise any one of a mechanical relay, electronic FET (Field Effect Transistor), or BJT (Bipolar Junction Transistor), and may be configured to enable bidirectional operation of the motor 30.

The switching module 203 may be configured to directly connect the first controller 150 and motor 30 according to control by the second processor 201 when the first controller 150 is in a normal state. At this time, the second controller 200 may check the state of the motor 30 while monitoring current of the motor 30. In particular, the second controller 200 may detect fault states such as open or short to determine abnormality of the motor 30.

Also, the switching module 203 may comprise a configuration for driving the motor 30 to operate the parking brakes 25, 26 when electrical failure of the first controller 150 occurs or power supply from the power supply unit 90 is cut off.

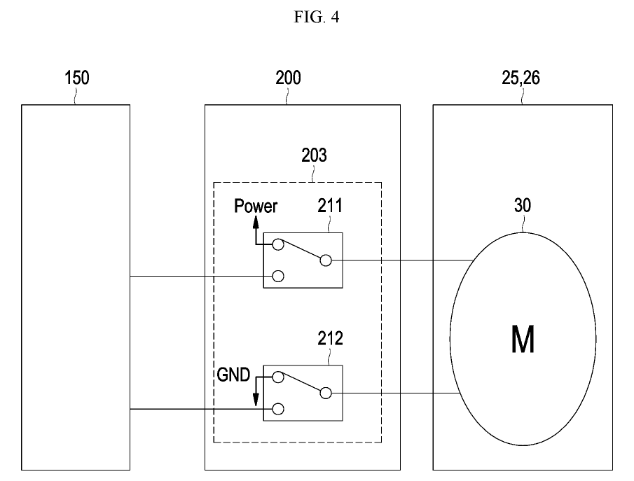

FIG. 4 is a diagram showing a configuration of a switching module of a second controller according to an embodiment of the disclosed invention.

Referring to FIG. 4 as one embodiment, the switching module 203 may comprise a first switching element 211 and second switching element 212 connected in series between the first controller 150 and motor 30. When the first controller 150 is in a normal state, the first switching element 211 and second switching element 212 may connect the first controller 150 and motor 30 based on control by the second processor 201. At this time, the second processor 201 may monitor drive current of the motor 30 to confirm normal operation of the motor 30.

Meanwhile, when the first controller 150 is in an abnormal state, the first switching element 211 may operate to connect a power supply path from the power supply unit 90 to the motor 30 based on control by the second processor 201. Also, when the first controller 150 is in an abnormal state, the second switching element 212 may operate to connect a ground path of the motor 30 based on control by the second processor 201.

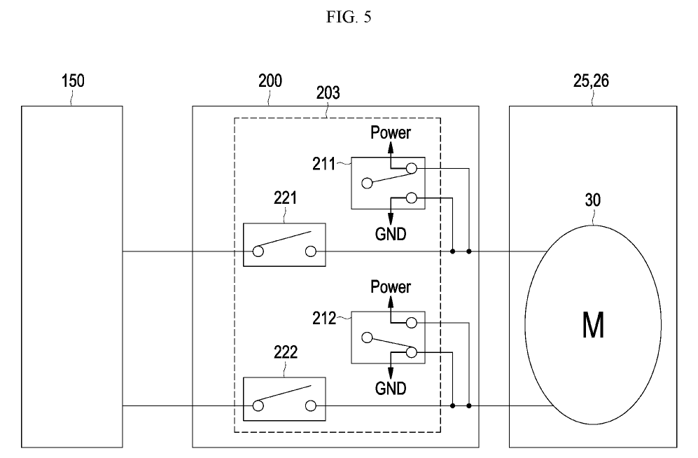

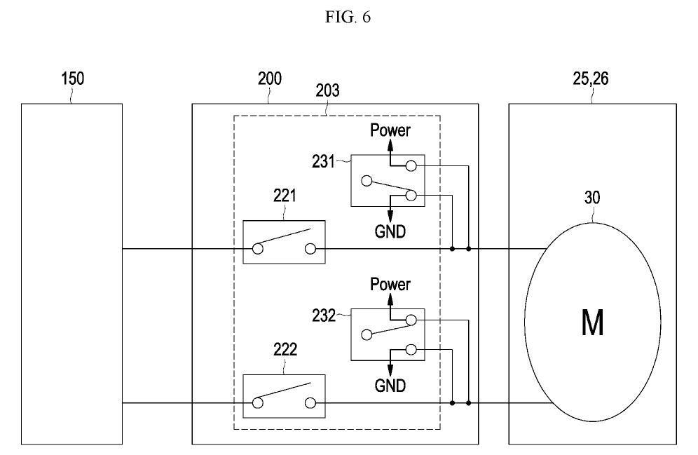

FIGS. 5 and 6 are diagrams showing configurations of switching modules of a second controller according to other embodiments of the disclosed invention.

Referring to FIGS. 5 and 6 as other embodiments, the switching module 203 may comprise first and second switching elements 211, 212 that control connection between the power supply unit 90 and motor 30 when the first controller 150 is in an abnormal state, and third and fourth switching elements 221, 222 connected in series between the first controller 150 and motor 30. Here, the first switching element 211 is connected between the third switching element 221 and motor 30, and the second switching element 212 is connected between the fourth switching element 222 and motor 30 to control operation of the motor 30.

As shown in FIG. 5, the second processor 201 may control the first switching element 211 to connect the power supply unit 90 and motor 30 for actuation of the parking brakes 25, 26 based on first rotation of the motor 30. Also, as shown in FIG. 6, the second processor 201 may control the second switching element 212 to connect the power supply unit 90 and motor 30 for release of the parking brakes 25, 26 based on second rotation of the motor 30. Here, the first rotation and second rotation of the motor 30 may be set as operation directions of the motor 30 related to actuation or release of the parking brakes 25, 26.

Through this, even in a vehicle 1 without a mechanical parking pawl in P position, the motor 30 may be driven bidirectionally for actuation or release of the parking brakes 25, 26.

For example, the second controller 200 may branch paths for supplying power to the motor 30 and perform the role of a motor driver for operation of the motor 30. This second controller 200 is connected between the first controller 150 and motor 30 to secure redundancy of the electronic brake system 1000.

Also, while the second controller 200 of FIG. 4 controls operation of the motor 30 to enable only actuation of the parking brakes 25, 26, the second controller 200 of FIGS. 5 and 6 controls operation of the motor 30 to enable both actuation and release of the parking brakes 25, 26, thereby improving functionality of the electronic brake system 1000.

Meanwhile, the second controller 200 may continuously check the state of the motor 30 to replace the first controller 150. For example, when fault states such as open or short are detected, the second processor 201 may immediately identify this and perform appropriate response operations. Through this monitoring function of the second controller 200, reliability and safety of the electronic brake system 1000 may be improved.

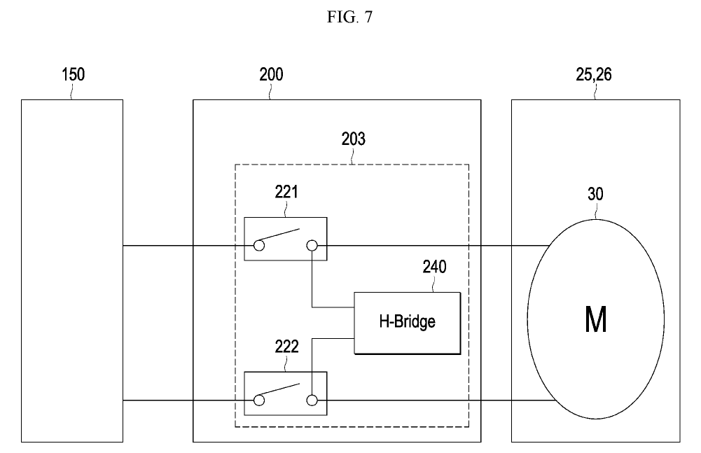

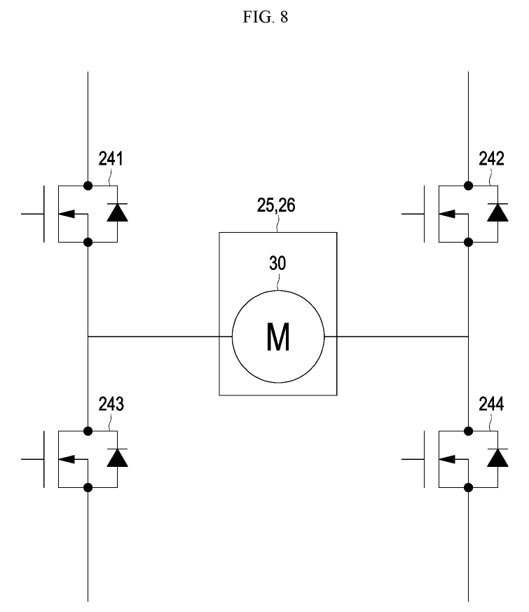

FIG. 7 is a diagram showing a configuration of a switching module of a second controller according to another embodiment of the disclosed invention. FIG. 8 is a diagram exemplarily showing a configuration of an H-bridge circuit shown in FIG. 7.

Referring to FIGS. 7 and 8 as another embodiment, the switching module 203 may comprise an H-bridge circuit 240 that controls connection between the power supply unit 90 and motor 30 based on control by the second processor 201 when the first controller 150 is in an abnormal state, and a fifth switching element 245 and sixth switching element 246 connected in series between the first controller 150 and motor 30.

As shown in FIG. 8, the H-bridge circuit 240 may be configured including first, second, third, and fourth bridge switching elements 241, 242, 243, 244, and through this bidirectional operation of the motor 30 is possible. For example, the H-bridge circuit 240 may control power supply for first rotation of the motor 30 through switching operations of the first bridge switching element 241 and fourth bridge switching element 244. Also, the H-bridge circuit 240 may control power supply for second rotation of the motor 30 through switching operations of the second bridge switching element 242 and third bridge switching element 243.

The second controller 200 may further comprise a power storage module 204 that stores power supplied from the power supply unit 90. The power storage module 204 is configured including at least one capacitor and may supply power to the motor 30 based on identification of an abnormal state of the power supply unit 90. At this time, the second processor 201 may monitor a charging state of the power storage module 204 and control it to maintain a preset voltage, or may control automatic charging when the charging amount falls below a set threshold value. Through this, the second processor 201 may always maintain the charging state of the power storage module 204 optimally to enable immediate response when an emergency situation occurs.

The second controller 200 may receive a wheel speed signal WSS from a wheel speed sensor 60 provided in the vehicle 1. The second processor 201 may compare the received wheel speed signal WSS with a preset reference value and control operation of the motor 30 based on the comparison result. Through this, appropriate braking force according to the driving state of the vehicle 1 may be provided. For example, the second processor 201 may compare the wheel speed signal WSS with a reference value set to about 5 km/h, or may compare vehicle speed identified based on the wheel speed signal WSS with a reference value set to about 5 km/h. At this time, when the wheel speed signal WSS or vehicle speed is below the reference value, the second processor 201 may control operation of the motor 30 related to actuation or release of the parking brakes 25, 26.

Also, the second controller 200 may prevent unintended actuation of the parking brakes 25, 26 during driving based on the wheel speed signal WSS received from the wheel speed sensor 60. The second processor 201 may restrict actuation of the parking brakes 25, 26 for safety when the received wheel speed signal WSS exceeds a preset reference value.

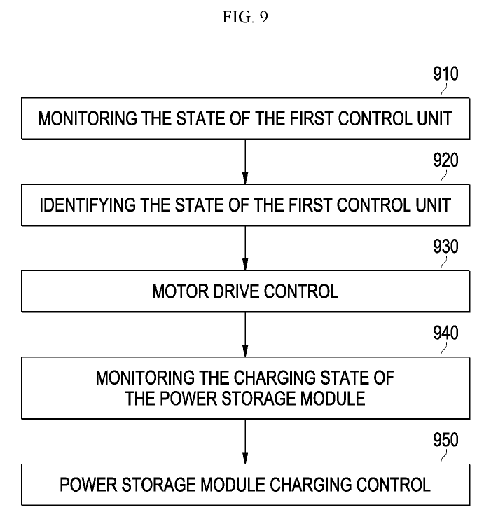

Hereinafter, referring to FIG. 9, a controlling method of an electronic brake system according to an embodiment of the disclosed invention will be described.

FIG. 9 is a diagram showing a controlling method of an electronic brake system according to an embodiment of the disclosed invention. Here, a controlling method performed by the electronic brake system 1000 described with reference to FIGS. 1-8 will be described.

Referring to FIG. 9, in the electronic brake system 1000, the second controller 200 may monitor a state of the first controller 150 (910). The second processor 201 may receive status information from the first controller 150 to monitor abnormal states. If a communication abnormality occurs between the first controller 150 and second controller 200, the second controller 200 may receive status information of the first controller 150 through bypass via an external other control unit (not shown).

Next, the second controller 200 may identify a normal state or abnormal state of the first controller 150 based on monitoring results (920). For example, the second processor 201 may detect information about power cutoff from the power supply unit 90 or abnormality occurrence in the brake module 100 based on status information received from the first controller 150, and may identify an abnormal state of the first controller 150 based on detection results.

Next, the second controller 200 may control operation of the motor 30 that actuates or releases the parking brakes 25, 26 of the electronic brake system 1000 based on identification results (930). The switching module 203 may maintain bypass connection between the first controller 150 and motor 30 based on control by the second processor 201 when the first controller 150 is in a normal state. Conversely, when the first controller 150 is in an abnormal state, the switching module 203 may open the bypass connection between the first controller 150 and motor 30 based on control by the second processor 201, and may control power supply for operation of the motor 30 using internal switching elements 211, 212, 221, 222.

The switching module 203 may directly connect the first controller 150 and motor 30 according to control by the second processor 201 when the first controller 150 is in a normal state. At this time, the second controller 200 may check the state of the motor 30 while monitoring current of the motor 30. In particular, the second controller 200 may detect fault states such as open or short to determine abnormality of the motor 30.

Also, the switching module 203 may control power supply for driving the motor 30 to operate the parking brakes 25, 26 when electrical failure of the first controller 150 occurs or power supply from the power supply unit 90 is cut off.

When the first controller 150 is in an abnormal state, the first switching element 211 may operate to connect a power supply path from the power supply unit 90 to the motor 30 based on control by the second processor 201. Also, when the first controller 150 is in an abnormal state, the second switching element 212 may operate to connect a ground path of the motor 30 based on control by the second processor 201.

Also, in a switching module 203 including first and second switching elements 211, 212 that control connection between the power supply unit 90 and motor 30 when the first controller 150 is in an abnormal state, and third and fourth switching elements 221, 222 connected in series between the first controller 150 and motor 30, the first switching element 211 may operate for actuation of the parking brakes 25, 26 based on first rotation of the motor 30 when the first controller 150 is in an abnormal state to connect the power supply unit 90 and motor 30. Also, when the first controller 150 is in an abnormal state, the second switching element 212 may operate for release of the parking brakes 25, 26 based on second rotation of the motor 30 to connect the power supply unit 90 and motor 30. Here, the first rotation and second rotation of the motor 30 may be set as operation directions of the motor 30 related to actuation or release of the parking brakes 25, 26.

Also, in a switching module 203 including an H-bridge circuit 240 that controls connection between the power supply unit 90 and motor 30 based on control by the second processor 201 when the first controller 150 is in an abnormal state, power supply for first rotation of the motor 30 or power supply for second rotation of the motor 30 may be controlled through switching operations of at least one of first, second, third, and fourth bridge switching elements 241, 242, 243, 244.

Meanwhile, the second controller 200 may receive the wheel speed signal WSS from the wheel speed sensor 60 provided in the vehicle 1, compare the received wheel speed signal WSS with a preset reference value, and control operation of the motor 30 based on the comparison result.

Next, the second controller 200 may monitor a charging state of the power storage module 204 (940). The second controller 200 including the power storage module 204 that stores power supplied from the power supply unit 90 may monitor the charging state of the power storage module 204.

Next, the second controller 200 may control charging of the power storage module 204 so that the power storage module 204 maintains a preset voltage (950). The second controller 200 may control charging of the power storage module 204 to maintain a preset voltage or may control the power storage module 204 to automatically perform charging when the charging amount falls below a set threshold value.

According to an aspect of the disclosed invention, control redundancy may be provided to enable normal operation of a motor even when an abnormality occurs in a device controlling operation of the motor.

Specifically, the electronic brake system of the disclosed invention implements a second controller between the first controller and parking brake motor, so that when the first controller operates normally, normal control is possible by maintaining bypass connection between the first controller and motor through the switching module of the second controller. Also, when power supply cutoff or failure of the first controller occurs, the second controller releases the bypass connection and directly controls the motor through internal switching elements to enable actuation and release of the parking brake. Also, the second controller comprises a power storage module including capacitors inside to enable motor operation even when power supply from the vehicle's power supply unit is cut off. Also, the second controller continuously monitors current of the motor to check fault states such as open or short, providing expandability to replace functions of an independent ECU. Also, by monitoring the charging state of the power storage module and controlling it to maintain a constant voltage, a ready state may be maintained to enable immediate response when an emergency situation occurs. Also, by utilizing output signals of the wheel speed sensor, appropriate braking force according to the vehicle's driving state may be provided, and unintended actuation of the parking brake may be prevented.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to comprise within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An electronic brake system comprising:
a motor configured to actuate or release a parking brake of the electronic brake system;
a first controller configured to control operation of the motor in a normal state; and
a second controller electrically connected between the first controller, a power supply unit of the vehicle, and the motor, the second controller configured to:
identify an abnormal state of the first controller, and
switch power supply paths for control operation of the motor based on an identification result,
wherein the second controller comprises:
a processor configured to identify the abnormal state of the first controller; and
a switching module configured to switch power supply paths to the motor based on control by the processor,
wherein the switching module is configured to:
maintain the electrical connection between the first controller and the motor based on control by the processor when the first controller is in a normal state, and
in response to identification of the abnormal state, disconnect the electrical connection between the first controller and the motor and form an electrical connection between the power supply unit and the motor so that the second controller controls the motor.

2. The electronic brake system of claim 1, wherein the switching module is configured to maintain bypass connection between the first controller and the motor when the first controller is in a normal state.

3. The electronic brake system of claim 1, wherein the switching module comprises at least one switching element configured to control connection between the first controller and the motor or between the power supply unit and the motor.

4. The electronic brake system of claim 3, wherein the switching module comprises a first switching element and a second switching element connected in series between the first controller and the motor,
wherein when the first controller is in a normal state, the first switching element and the second switching element connect the first controller and the motor based on control by the processor, and when the first controller is in an abnormal state, the first switching element operates to connect a power supply path from the power supply unit to the motor based on control by the processor, and the second switching element operates to connect a ground path of the motor based on control by the processor.

5. The electronic brake system of claim 3, wherein the switching module comprises:
a first switching element and a second switching element configured to control connection between the power supply unit and the motor when the first controller is in an abnormal state; and a third switching element and a fourth switching element connected in series between the first controller and the motor, wherein the first switching element is connected between the third switching element and the motor, and the second switching element is connected between the fourth switching element and the motor.

6. The electronic brake system of claim 5, wherein the processor controls the first switching element to connect the power supply unit and the motor for actuation of the parking brake based on first rotation of the motor, and controls the second switching element to connect the power supply unit and the motor for release of the parking brake based on second rotation of the motor.

7. The electronic brake system of claim 3, wherein the switching module comprises: an H-bridge circuit including first, second, third, and fourth switching elements configured to control connection between the power supply unit and the motor based on control by the processor when the first controller is in an abnormal state; and a fifth switching element and a sixth switching element connected in series between the first controller and the motor.

8. The electronic brake system of claim 3, wherein the switching element comprises any one of a mechanical relay, an electronic FET, and a BJT.

9. The electronic brake system of claim 1, wherein the second controller further comprises a power storage module configured to store power supplied from the power supply unit.

10. The electronic brake system of claim 9, wherein the power storage module comprises at least one capacitor and supplies power to the motor based on identification of an abnormal state of the power supply unit.

11. The electronic brake system of claim 9, wherein the processor monitors a charging state of the power storage module and controls it to maintain a preset voltage.

12. The electronic brake system of claim 1, wherein the second controller controls operation of the motor based on a wheel speed signal from a wheel speed sensor provided in the vehicle.

13. The electronic brake system of claim 12, wherein the processor compares the wheel speed signal with a preset reference value and controls operation of the motor based on a comparison result.

14. The electronic brake system of claim 1, wherein the second controller receives status information of the first controller from the first controller, and the processor identifies the abnormal state of the first controller based on the status information.

15. A controlling method of an electronic brake system comprising:
monitoring, by a second controller of the electronic brake system, a state of a first controller;
identifying, by the second controller, a normal state or abnormal state of the first controller based on a monitoring result; and
switching power supply paths for operation of a motor that actuates or releases a parking brake of the electronic brake system based on an identification result.

16. The controlling method of claim 15, wherein in the step of switching power supply paths, when the first controller is in a normal state, connection between the first controller and the motor is maintained, and in response to identification of the abnormal state, electrical connection between the first controller and the motor is disconnected and electrical connection between the power supply unit and the motor is formed so that the second controller controls the motor.

17. The controlling method of claim 16, wherein in the step of switching power supply paths, when the first controller is in an abnormal state, a first switching element is controlled to connect the power supply unit and the motor for actuation of the parking brake based on first rotation of the motor, and a second switching element is controlled to connect the power supply unit and the motor for release of the parking brake based on second rotation of the motor.

18. The controlling method of claim 16, wherein the step of switching power supply paths further comprises monitoring a state of the power supply unit, and when the power supply unit is in an abnormal state, driving the motor using power stored in a power storage module.

19. The controlling method of claim 15, wherein the step of switching power supply paths further comprises receiving a wheel speed signal from a wheel speed sensor provided in the vehicle, comparing the wheel speed signal with a preset reference value, and controlling operation of the motor based on a comparison result.

20. The controlling method of claim 15, further comprising: monitoring a charging state of a power storage module; and controlling the power storage module to maintain a preset voltage.
